(19) United States
(12) Patent Application Publication
(10) Pub. No.: US 2009/0002162 A1
(43) Pub. Date: Jan. 1, 2009

(54) Computer theft deterrence technology

(76) Inventor: Duncan Glendinning, Chandler, AZ (US)

Correspondence Address: Kraguljac & Kalnay, LLC, C/O INTELLEVATE LLC, P.O BOX 52050, MINNEAPOLIS, MN, 55402, US

(21) Appl. No.: 11/824,432

(22) Filed: Jun. 29, 2007

(51) Int. Cl. G08B 13/14

(52) U.S. Cl. 340/571

(57) ABSTRACT

A system embodiment associated with making a computer a less desirable target for a thief is described. A system embodiment may include a security timer that is to be periodically refreshed. If the security timer is not periodically refreshed, then a computer in which the system embodiment is located may be disabled by a theft deterrence logic. The system embodiment may also include a communication logic to communicate with a TDSP to request a signal to update the security timer. While a system embodiment is described, it is to be appreciated that other system embodiments having different elements and that method embodiments may be described.

### BACKGROUND

Computer Theft Deterrence Technology (CTDT) relates to making a portable computer (e.g., laptop, notebook) a less desirable target to a thief. Conventional CTDT may rely on an operating system to disable a stolen computer, to help locate a stolen computer, and so on. However, some conventional CTDT may be circumvented by replacing the operating system.

### BRIEF DESCRIPTION OF THE DRAWINGS

The accompanying drawings, which are incorporated in and constitute a part of the specification, illustrate embodiments of various aspects of the invention. It will be appreciated that the illustrated element boundaries (e.g., boxes, groups of boxes, or other shapes) in the figures represent one embodiment of the boundaries. One of ordinary skill in the art will appreciate that unless otherwise stated one element may be designed as multiple elements, multiple elements may be designed as one element, an element shown as an internal component of another element may be implemented as an external component and vice versa, and so on. Furthermore, elements may not be drawn to scale.

FIG. 1 illustrates a computer with an embodiment of a theft deterrence system.

FIG. 2 illustrates a computer with an embodiment of a theft deterrence logic.

FIG. 3 illustrates a method embodiment associated with computer theft deterrence.

FIG. 4 illustrates an embodiment of a computing device in which a theft deterrence logic may be located.

### DETAILED DESCRIPTION

System and method embodiments described herein implement a Theft Deterrence System (TDS). Some embodiments may utilize hardware and cryptographic capabilities provided by an integrated embedded controller (IEC) to implement the TDS. In some embodiments the TDS does not implement a conventional stolen computer retrieval mechanism but rather facilitates disabling specific capabilities of a stolen computer. Identifying a computer as being configured with a TDS may make it less likely that the computer will be stolen because a potential thief will recognize that the TDS-configured computer will not operate after being stolen.

Some portions of the detailed descriptions that follow are presented in terms of algorithm descriptions and representations of operations on electrical and/or magnetic signals capable of being stored, transferred, combined, compared, and otherwise manipulated in hardware. These are used by those skilled in the art to convey the substance of their work to others. An algorithm is here, and generally, conceived to be a sequence of operations that produce a result. The operations may include physical manipulations of physical quantities (e.g., electrical, magnetic).

It has proven convenient to refer to these electrical and/or magnetic signals as bits, values, elements, symbols, characters, terms, numbers, protocol messages, and so on. It is appreciated that terms including processing, computing, calculating, determining, displaying, automatically performing an action, and so on, refer to actions and processes of a computer system, logic, processor, or similar electronic device that manipulates and transforms data represented as physical (electric, electronic, magnetic) quantities.

Method embodiments may be better appreciated with reference to flow diagrams. While for purposes of simplicity of explanation, method embodiments are shown and described as a series of blocks, it is to be appreciated that these embodiments are not limited by the order of the blocks, as some blocks can occur in different orders and/or concurrently with other blocks from that shown and described. In some embodiments, blocks may be implemented in logic. In other embodiments, processing blocks may represent functions and/or actions performed by functionally equivalent circuits (e.g., an analog circuit, a digital signal processor circuit, an application specific integrated circuit (ASIC)), or other logic device. Blocks may represent executable instructions that cause a computer, processor, and/or logic device to respond, to perform an action(s), to change states, and/or to make decisions.

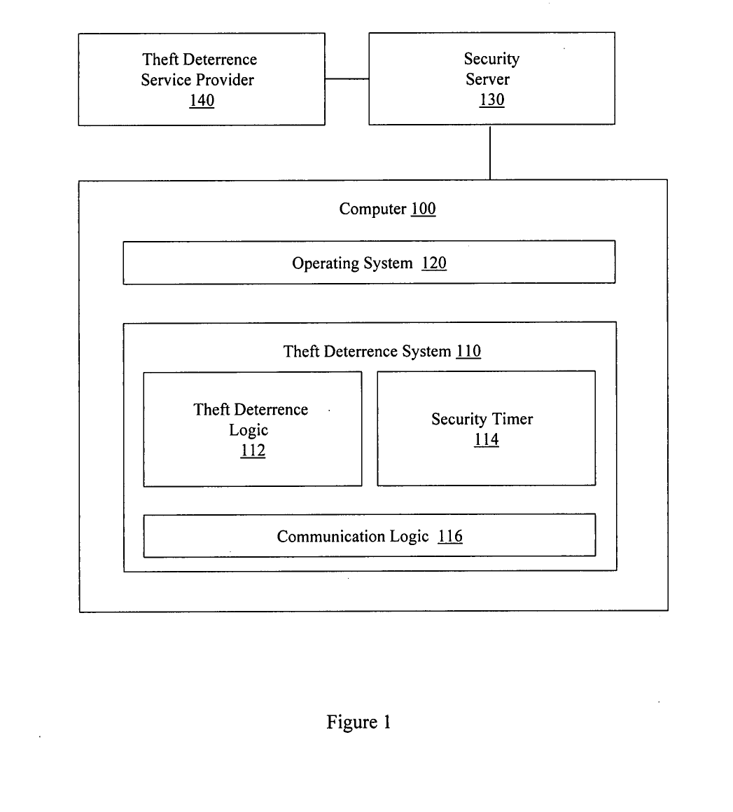

FIG. 1 illustrates a computer 100. Computer 100 may have a theft deterrence system (TDS) 110 in accordance with at least some aspects of the invention. TDS 110 may include a theft deterrence logic 112 and a security timer 114. TDS 110 may also include a communication logic 116 for communicating with a theft deterrence service provider (TDSP) 140 through a security server 130. In some embodiments, a logic may include hardware, firmware, software in execution and/or combinations thereof to perform a function(s) or an action(s), and/or to cause a function or action from another logic, method, and/or system. In some embodiments, a logic may include a software controlled microprocessor, discrete logic (e.g., application specific integrated circuit (ASIC)), an analog circuit, a digital circuit, a programmed logic device, a memory device containing instructions, and so on. Computer 100 may include an operating system 120.

Theft deterrence logic 112 may examine security timer 114 to determine whether to disable computer 100. Security timer 114 may be reset based on communications with TDSP 140 accomplished through communication logic 116. If computer 100 is stolen, the owner of computer 100 may report it stolen to TDSP 140. The reporting may take the form of a phone call, an email, entering data at a website, and so on. TDSP 140 will then consider computer 100 to be in a “stolen” state. Thus, TDSP 140 may not respond to communications from TDS 110 to refresh security timer 114, but may respond with a message to immediately disable computer 100. Since requests from TDS 110 to TDSP 140 may go unanswered, security timer 114 may not be reset and theft deterrence logic 112 may disable computer 100.

As described above, computer 100 may interact with a TDSP 140. While a single TDSP 140 is illustrated, it is to be appreciated that a set of servers arranged in different physical locations and available via different communication paths, protocols, and networks may provide a selective refresh service. In some embodiments, computer 100 may communicate with TDSP 140 via a security server 130. While a single security server 130 is illustrated, it is to be appreciated that a set of servers located in different physical locations and accessible through different networks, protocols, and so on may be employed. TDSP 140 may be tasked with sending a signal upon receipt of a message from TDS 110. The signal may cause the security timer 114 to be reset. Therefore, messages may flow between computer 100 and TDSP 140 on a periodic basis. These messages may control, at least in part, whether security timer 114 is reset and thus whether theft deterrence logic 112 will disable the computer 100. In some embodiments, that signal may be an electrical signal, an optical signal, an analog signal, a digital signal, data, a computer instruction and so on that can be received, transmitted and/or detected.

In some embodiments, the frequency with which messages may flow between TDSP 140 and computer 100 may be determined by the security timer 114. For example, security timer 114 may be programmed to alert theft deterrence logic 112 and/or communication logic 116 on a policy based schedule that a refresh signal is needed. The computer 100 may continue to operate as long as the security timer 114 is reset based on a signal received from the TDSP 140 before a predetermined time period has elapsed. If the computer 100 has been reported stolen, then the TDSP 140 may not respond to a request to reset the security timer 114. Additionally, and/or alternatively, if the computer 100 has been reported stolen, then the TDSP 140 may send a “stolen” message to TDS 110. This stolen message may cause security timer 114 to prematurely time out. When the security timer 114 expires, the computer 100 may be disabled by TDS 110 and thus become substantially worthless to a thief. Disabling computer 100 may include, for example, disrupting power to computer components that are not part of the TDS 110, disrupting communications between computer components that are not part of the TDS, disabling certain drivers (e.g., keyboard, monitor, memory), and so on. In some embodiments, a computer component may be a computer-related entity (e.g., hardware, firmware, software, software in execution, combinations thereof that may include, for example, a process running on a processor, a processor, an object, an executable, a thread of execution, a program, a computer, and so on.

In some embodiment, the theft deterrence system 110 may be implemented in an integrated embedded controller (IEC) that is a separate component from the operating system. In some embodiments, where the IEC is implemented at the microcode level and embedded in a chip in the computer 100 chipset, the IEC cannot be circumvented, even when the operating system 120 is replaced.

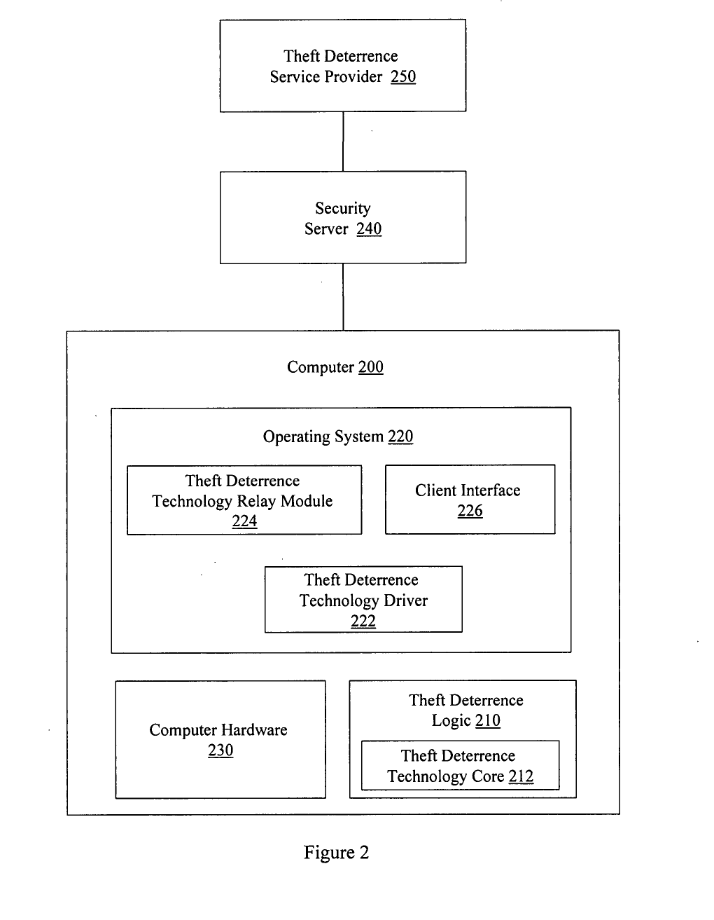

FIG. 2 illustrates a computer 200. Computer 200 may include a theft deterrence logic 210 in accordance with at least some aspects of the invention. Computer 200 may also include an operating system 220. Operating system 220 may run on computer hardware 230. Computer hardware 230 may include a set of chips that may implement an IEC at the microcode level.

Theft deterrence logic 210 may communicate with a TDSP 250 through the operating system 220 and/or through an out-of-band mechanism. The theft deterrence logic 210 may include a theft deterrence technology core 212. The theft deterrence technology core 212 may have a security timer that can be used to enable and/or disable the computer 200 based on communications with the TDSP 250.

Computer 200 may include a theft deterrence technology driver 222 to communicate with theft deterrence technology core 212. The theft deterrence technology driver 222 may be used by the operating system 220 to convert protocol used by the theft deterrence logic 210 depending on the communication path to the TDSP 250. Computer 200 may also include a theft deterrence technology relay module 224 to facilitate communications with a security server 240. The theft deterrence technology relay module 224 may be used to translate data from the TDSP 250 for use in a client interface 226. The theft deterrence technology relay module 224 may also pass information to the theft deterrence logic 210. In some embodiments, the theft deterrence technology driver 222 may be implemented at the kernel level of operating system 220 while the upper theft deterrence technology module may be implemented at the user level of operating system 220.

Computer 200 may also include a client interface 226 to allow a user to enter parameters or to view the status of the theft deterrence technology core 212. If the computer 200 is disabled, the client interface 226 may allow a user to receive messages or codes for re-enabling the computer 200.

In some embodiments, computer 200 may rely on an IEC to enable computer 200 to operate in a normal mode. This normal mode may be used when a computer has not been reported stolen. The IEC may interact with and/or contain the theft deterrence logic 210. The IEC may be a separate component from operating system 220. Operating system 220 may be replaced as needed without affecting the IEC. Having theft deterrence logic 210 rely on the IEC instead of on the operating system 220 mitigates security issues associated with conventional systems. Thus, conventional approaches to circumventing theft deterrence systems that rely on replacing, hacking, and/or otherwise manipulating an operating system may be frustrated.

In some embodiments, computer 200 may rely on the IEC to communicate with TDSP 250 through a security server 240. These communications may occur using the out-of-band capabilities of the IEC. This will enable computer 200 to continue normal operation with respect to theft deterrence even if the operating system 220 experiences unauthorized manipulation. This may also facilitate communications between a stolen computer and TDSP 250 that may lead to the computer becoming disabled. Therefore, even replacing the operating system 220 may not defeat the theft deterrence provided by theft deterrence hardware logic 210.

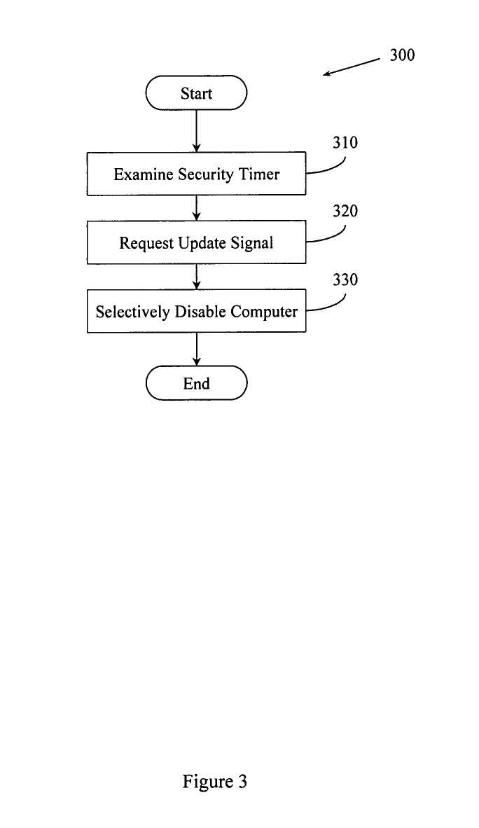

FIG. 3 illustrates a method associated with computer theft deterrence in accordance with at least some aspects of the invention. Method 300 may include, at 310, examining a security timer. The security timer may be located, for example, in an IEC implemented at the microcode level of a chipset of a computer. The security timer may be examined to determine whether to disable a computer in which method 300 is being performed. The computer may be disabled when the timer enters a state associated with the computer being stolen.

Method 300 may also include, at 320, requesting from an external security provider a signal to update the security timer. This signal may be requested periodically based, for example, on a policy based refresh cycle. A computer may be configured to request a refresh signal at periods including, for example, once every N seconds, once every N minutes, once every N hours, once every N executed instructions, (N being a number), and so on. If the refresh signal is received, the security timer may be refreshed and normal operation may continue. However, if the refresh signal is not received, then the computer may become disabled. In some embodiments, a message sent to the security provider requesting the refresh signal may be an encrypted message. In some embodiments, the message may be communicated to the security provider using an out-of-band communication path that bypasses an operating system associated with the computer on which method 300 is executing.

Method 300 may also include, at 330, disabling the computer upon determining that the security timer has expired. The security timer may expire when the security provider decides not to send the refresh signal. The security provider may decide not to send the refresh signal when the computer has been reported stolen. Since the computer may be disabled, in some embodiments the computer may also be re-enabled after receiving an enabling key from the security provider.

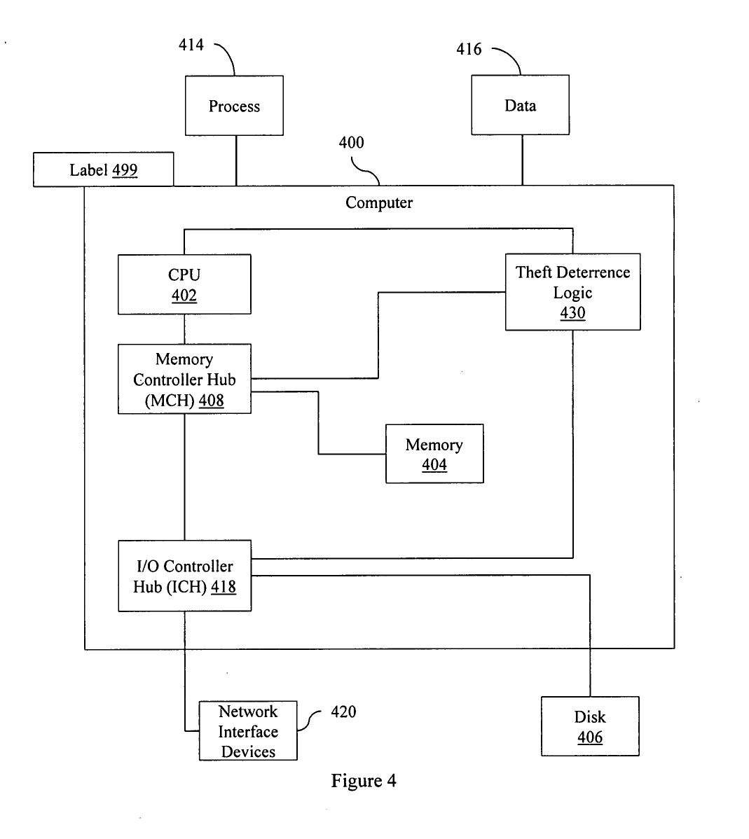

FIG. 4 illustrates a computer 400 having a theft deterrence logic 430 and a label 499. Theft deterrence logic 430 may implement embodiments of various systems and methods described herein in accordance with at least some aspects of the invention and label 499 may provide indicia that computer 400 has a TDS. In different embodiments, the logic 430 may be implemented in hardware, software, firmware, and/or combinations thereof. In some embodiments, the software may include computer instructions and/or processor instructions. Software may cause a computer, processor, or other electronic device to perform functions, actions and/or behave in a desired manner. In different embodiments, computer-readable and/or executable instructions may be located in one logic and/or distributed between multiple communicating, co-operating, and/or parallel processing logics and thus may be loaded and/or executed in serial, parallel, massively parallel and other manners.

Computer 400 may include a central processing unit (CPU) 402 and a memory 404. A disk 406 may be operably connected to the computer 400 via, for example, an input/output controller hub (ICH) 418. The memory 404 can store a process 414 and/or a data 416, for example. The disk 406 and/or the memory 404 can store an operating system that controls and allocates resources of the computer 400. In some embodiments, an “operable connection” or a connection by which entities are “operably connected”, is one in which signals, physical communications, and/or logical communications may be sent and/or received. An operable connection may include a physical interface, an electrical interface, and/or a data interface.

The computer 400 may include a memory controller hub (MCH) 408 to operably connect the CPU 402, memory 404, ICH 418, and theft deterrence logic 430. In some embodiments, the IEC maybe integrated directly into the MCH 408 to provide a secure storage and code execution environment for the theft deterrence system. Thus, in some embodiments, logic 430 may be integrated into MCH 408. The computer 400 can operate in a network environment and thus may be connected to network interface devices 420 via the ICH 418.

Computer 400 may be, for example, a mobile platform (e.g., laptops, notebooks) that has an IEC. In some embodiments, the IEC may be integrated into a chipset to provide a secure data storage and code execution environment that is less susceptible to unauthorized manipulation than higher level (e.g., operating system) mechanisms. The IEC may implement an internal secure timer and may be configured to communicate with an external policy server (PS) at a policy based time interval. The communication may request authorization to reset the internal secure timer. The authorization may be provided when the computer is in a “not stolen” state. The internal secure timer and the TDS allow a computer to function normally as long as the timer does not time out. If the computer is stolen, then a user-initiated action (e.g., reporting theft) may cause the computer to enter a “stolen” state at the external PS. When the computer is in the stolen state, then the PS may not respond to the computer request for a timer refresh, in which case the internal secure timer may time out. When the timer times out, the computer may become disabled. Over time, market awareness may develop with respect to TDS-configured computers becoming disabled after being stolen, which may make such computers less attractive targets.

Note that the communications between the IEC and the PS may be operating system independent. The IEC may be part of a comprehensive set of tools that facilitate both in-band and out-of-band communication and management. In some embodiments, the IEC may be part of an active management logic that facilitates discovering, healing, and protecting computing assets independent of an operating system. Thus, the IEC may be viewed as a separate system that operates independent of the operating system. Therefore, when computer 400 has a TDS that relies on an IEC rather than on an operating system, computer 400 may not be vulnerable to operating system reinstallation, or nonvolatile mass storage device (e.g., disk drive) replacement followed by operating system reinstallation.

What is claimed is:

1. A system, comprising:
a security timer;
a communication logic to communicate with a theft deterrence service provider (TDSP) to request a signal to update the security timer; and
a theft deterrence logic to disable a computer associated with the system, the theft deterrence logic to disable the computer upon the expiration of the security timer,
at least one of the security timer, the communication logic, and the theft deterrence logic being part of an integrated embedded controller (IEC), the IEC being a member of a chipset of the computer.

2. The system of claim 1, where the theft deterrence logic is to periodically request the signal to update the security timer.

3. The system of claim 2, where the TDSP will not provide the signal to update the security timer upon determining that the computer housing the system has been stolen.

4. The system of claim 3, the IEC being implemented in microcode.

5. The system of claim 4, where the security timer, the communication logic, and the theft deterrence logic are part of the IEC.

6. The system of claim 1, the communication logic to communicate with the TDSP using one or more of, an out-of-band path not associated with an operating system associated with the computer, or an in-band path utilizing the operating system to relay messages between the theft deterrence logic and the TDSP.

7. The system of claim 1, the signal being a cryptographically signed and encrypted absolute time value.

8. The system of claim 7, the TDSP to re-enable the computer by providing an enabling key.

9. The system of claim 8, the enabling key being an absolute time value.

10. The system of claim 1, the communication logic to encrypt communications from the theft deterrence logic to the TDSP.

11. The system of claim 10, the communication logic to encrypt communications to the TDSP using Public Key Infrastructure (PKI).

12. A method, comprising:
examining a security timer of an IEC implemented at the microcode level in a chipset of a computer;
requesting from an external security provider a signal to update the security timer; and
disabling the computer upon determining that the security timer has expired.

13. The method of claim 12, including:
receiving the signal to update the security timer; and
updating the security timer.

14. The method of claim 13, including:
encrypting a message requesting the signal to update the security timer; and
communicating the message to the external security provider using an out-of-band path.

15. The method of claim 14, including:
receiving an enabling key from the external security provider; and
re-enabling a previously disabled computer based, at least in part, on the enabling key.
